(19) United States
(12) Patent Application Publication
(10) Pub. No.: US 2004/0246071 A1
(43) Pub. Date: Dec. 9, 2004

(54) Radio-frequency filter, in particular in the form of a duplex filter

(75) Inventors: Franz Rottmoser, Schechen (DE); Wilhelm Weitzenberger, Simbach am Inn (DE)

Correspondence Address: NIXON & VANDERHYE, PC, 1100 N GLEBE ROAD, 8TH FLOOR, ARLINGTON, VA, 22201-4714, US

(73) Assignee: Kathrein-Werke KG, Rosenheim (DE)

(21) Appl. No.: 10/753,397

(22) Filed: Jan. 9, 2004

(30) Foreign Application Priority Data
Jun. 5, 2003 (DE) 103 25 595.8

(51) Int. Cl. H01P 1/213; H01P 1/203

(52) U.S. Cl. 333/134; 333/204

(57) ABSTRACT

An improved radio-frequency filter is distinguished by the following features:

the resonators (9, 19) are coupled to the continuous line (3) through a dielectric, preferably in the form of the board or of the substrate (1),

at least a portion of the resonators (9, 19) is arranged such that, when viewed at right angles to the board or to the substrate (1), at least a portion of the resonator (9, 19) overlaps the continuous line (3), and

in the area or section in which the continuous line (3) overlaps at least one section or one portion of the resonators (9, 19), the continuous line (3) has a line constriction (5a) or a broadened line area (5b), at least for one resonator (9, 19),

The invention relates to radio-frequency filters, in particular in the form of a duplex filter, according to the precharacterizing clause of claim 1.

In radio systems, for example in the field of mobile radio, only one common antenna is frequently used for the transmitted and received signals. The transmitted and received signals in this case use different frequency ranges. The antenna that is used must be suitable for transmission and reception in both frequency ranges. Suitable frequency filtering is therefore required to separate the transmitted and received signals, in order to ensure that, on the one hand, the transmitted signals can pass from the transmitter only to the antenna (and not in the direction of the receiver) and that, on the other hand, the received signals are passed on from the antenna only to the receiver, and do not lead to interference with the transmitter.

Suitable pairs of radio-frequency filters may in each case be used for this purpose.

Different concepts can be implemented using radio-frequency filters such as these. For example, it is possible to use one pair of radio-frequency filters which both pass a specific (namely in each case the desired) frequency band (bandpass filters). However, it is also possible to use a pair of radio-frequency filters which both block a specific (namely the respective undesired) frequency band (bandstop filters). Furthermore, however, it is also possible to use a pair of radio-frequency filters which are in the form of filters, one of which filters passes frequencies below a frequency that is between the transmission band and the reception band and blocks frequencies above this (low-pass filter), while the other filter blocks frequencies below the frequencies that are between the transmission and reception bands and passes those which are above it (high-pass filters). Finally, further combinations of the said filter types are also possible.

One of the known embodiments of such filters is based on stripline technology, microstrip conductors or so-called suspended substrate stripline technology. These techniques are useful since they require only a small amount of space and the production costs are low.

By way of example, the prior publication “Microwave Journal” Volume 45, No. 10, October 2002 discloses suspended substrate stripline technology in an article entitled “Reviewing the Basics of Suspended Striplines”. According to this prior publication, a single resonator based on suspended substrate stripline technology may comprise a conductive surface on a dielectric substrate (board). The dielectric board, that is to say the substrate, is fixed at a certain distance from and parallel to a conductive surface, which forms the ground surface. The volume between the lower face of the substrate and the ground surface is generally filled with air, but may also be composed of other dielectrics. In the case of a single resonator, the conductive surface which has been mentioned is then either provided on the face of the substrate which faces away from the ground surface, or else is provided on the opposite face, facing the ground surface. One end of a resonator may in this case be short-circuited, with the other end not being short-circuited. In this case, the mechanical length of the resonator corresponds to one quarter of the electrical wavelength. If neither of the ends is short-circuited, the mechanical length corresponds to half the electrical wavelength. The resonant frequency of the suspended substrate resonator itself is governed by its length.

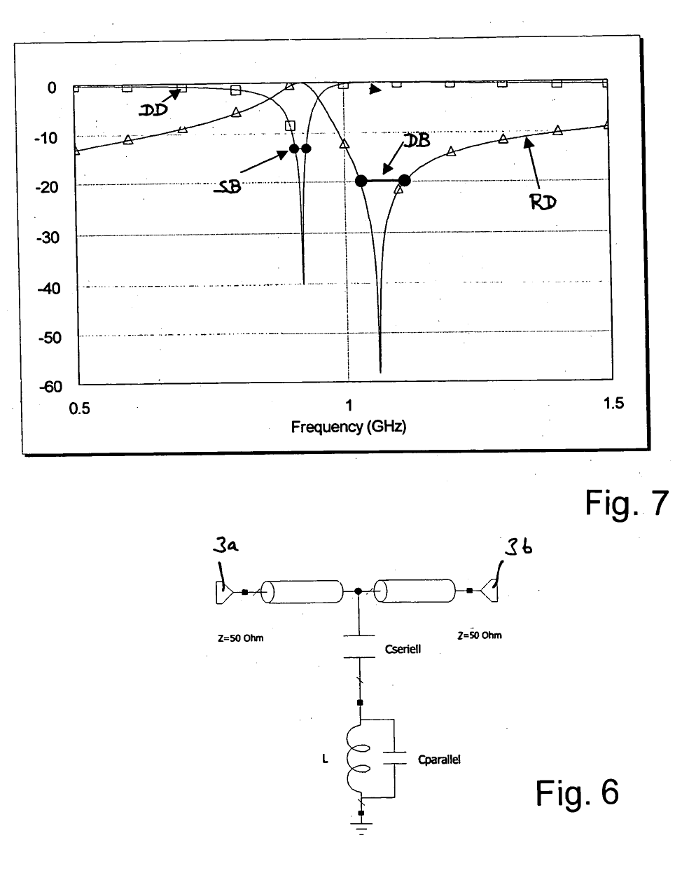

A radio-frequency filter of this generic type is disclosed, for example, in the prior publication “MICROSTRIP FILTERS FOR RF/MICROWAVE APPLICATIONS”, Jia-Sheng Hong and M. J. Lancaster, 2001, in particular in Figure 6.5 on page 170. By way of example, this describes an electrical line using stripline technology, with two or more U-shaped resonators or linear resonators, that is to say resonators which run in the form of a strip, being provided a short distance away, adjacent to this line. The linear resonators or the limbs of the U-shaped resonators in this case run at right angles to the line, which is in the form of a stripline. The lateral distance between the individual resonators in the direction of the stripline is in each case λ/4.

In the case of the already known solution explained above, the continuous line, which generally has a characteristic impedance of 50 ohms, is capacitively coupled to the linear resonators, and is inductively coupled to the U-shaped resonators. The degree of coupling is governed by the distance between the line and the resonator, by the width of the resonator, and by the characteristics of the substrate material (substrate height and dielectric constant). Since the structure is symmetrical, the degree of coupling can be determined by calculation from a low-pass filter prototype.

In the case of microstriplines, the higher dielectric constant of the substrate material means that the field concentration in the substrate is higher than in the air. A circuit such as this results in high dielectric losses owing to impurities in the substrate material and owing to the high field concentration in the substrate. In addition, the smaller size of the conductor structures results in increased field concentrations in the area of the metallic conductors. Owing to the resistance of the metallic surface, this leads to conductor losses. These two factors result in relatively high losses for microstrip circuits. A further disadvantage of this technique is the sensitivity of the coupling to etching tolerances and to scatter in the dielectric constants of the substrate material.

The design of filter structures such as bandpass filters, high-pass filters, low-pass filters or bandstop filters using suspended substrate technology offers the advantage over conventional microstripline technology that the dielectric and metallic losses can be minimized. The air gap between the substrate and the ground surface reduces the influence of the substrate material on the field concentration and the effective dielectric constant. The smaller the proportion of the substrate (that is to say the height of the substrate in comparison to the air component) and the greater the proportion of the air (that is to say the distance between the substrate and the ground surface), the less are the dielectric losses of the circuit. Furthermore, this makes it possible to reduce the influence of manufacturing-dependent fluctuations in the dielectric constant of the substrate material to the electrical characteristics of the circuit.

In addition to the abovementioned prior art, which forms this generic type, it is likewise already known for a radio-frequency filter or, in general, a bandstop filter to be designed using suspended substrate technology, such that the resonators are provided alternately on the upper face and on the lower face of the substrate, thus providing coupling between the individual resonators in the bandstop filter, that is to say the high-pass or low-pass filter, through the substrate.

Bandpass filters are frequently used for the filters in the field of mobile radio. Inter alia, these offer the capability to match the bandpass response to specific requirements, within certain limits, by the insertion of cross-couplings. Since the bandpass response of a Tschebyscheff bandpass filter is in principle symmetrical, it is not always possible to use the smallest possible number of resonators for asymmetric arrangements. However, this intrinsically unnecessary increase in the number of resonators also increases the losses. The manufacturing cost and the adjustment effort as well as the physical volume of a filter such as this are likewise disadvantageously influenced.

The object of the present invention is thus to provide an improved radio-frequency filter (RF filter), for example in the form of a bandstop filter, which can also be used in particular for a duplex filter.

According to the invention, the object is achieved by the features specified in claim 1. Advantageous refinements of the invention are specified in the dependent claims.

The present invention provides an improved radio-frequency filter, in particular an improved bandstop filter, especially in the form of a duplex filter as well, which has an improved RF bandstop and bandpass response, with a comparatively low degree of construction and assembly effort, and a small physical volume, overall.

The solution according to the invention for the filter or duplex filter is achieved using suspended substrate stripline technology in order—as explained—to keep the line and substrate losses as low as possible from the start.

However, according to the invention, it has now become possible to design bandstop filters so as to achieve an asymmetric stop band response. This means a reduction in the frequency separation between the stop band and the pass band on one side of the stop band, with a simultaneous increase in the frequency separation between the stop band and the pass band on the other side of the stop band.

The circuit of the bandstop filter, for example using capacitively coupled resonators, results in an increase in the gradient of the transition from the stop band to the pass band at the upper or higher edge of the stop band. In contrast, the circuit for the bandstop filter using inductively coupled resonators leads to an increase in the gradient of the transition from the stop band to the pass band at the lower edge of the respective stop band. The invention provides for the elements of the circuit to be fitted on both the upper face and lower face of the substrate. The coupling through the substrate makes it possible to reduce the influence of the dielectric constants of the substrate material, and the influence of the etching tolerances. In addition, it is thus possible to achieve a greater degree of coupling between two lines, that is to say resonators, or to couple one resonator to a greater extent to a continuous line.

The advantage of asymmetric bandstop filters is that a specific bandstop requirement can be achieved with a considerably smaller number of resonators than in the case of a conventional bandpass filter structure. Furthermore, a filter such as this or a duplex filter such as this can pass direct current and low-frequency signals. This means that no separate apparatus is required for any supply or data lines to bypass the filter.

The invention therefore provides for the stripline resonators to be coupled through a dielectric to a continuous line and, furthermore, in the process, for a continuous line with steps to be provided, to be precise preferably at the coupling areas or coupling points of the resonators. The steps in the continuous line may be designed in the form of a broadened area of the line or else in the sense of a constriction in the width of the line (line constriction), and thus in the line cross section.

Thus, in the end, it is possible to achieve a frequency response with an asymmetric bandstop or pass band effect.

An RF filter such as this or a bandstop filter such as this is, however, normally designed such that the continuous line is in each case provided at its opposite end with a connecting socket to which, for example, the connection to a transmitter or to a receiver can be connected.

In one preferred embodiment, two such RF filters, that is to say preferably two such bandstop filters, can be interconnected to form a duplex filter in which, furthermore, the continuous line is preferably provided with a total of three connecting sockets. The two outer sockets may firstly lead to a transmitter and secondly to a receiver, with the third socket producing a connection for a common transmission path which, in the preferred application, leads to a common antenna. A radio-frequency filter such as this is therefore particularly suitable for a mobile radio base station. However, the duplex filter may likewise be accommodated in a particularly preferred manner permanently installed in a mobile radio antenna as well, that is to say, in the case of a stationary mobile radio antenna that is mounted on a mast, normally in the antenna itself, that is to say within the radome of the antenna or adjacent to the antenna on a flange, on the antenna mast, or on the antenna tower itself.

In one particularly preferred embodiment, a bandstop filter with capacitively coupled resonators is connected to a bandstop filter with inductively coupled resonators, thus making it possible to produce a frequency filter with a very narrow transitional region between the two frequency bands.

Finally, in one preferred embodiment, it is likewise possible to provide for the radio-frequency filter to have no defined state in the UMTS gap, that is to say preferably in the frequency range between 1980 MHz and 2110 MHz.

The invention will be explained in more detail in the following text with reference to exemplary embodiments. In this case, in detail:

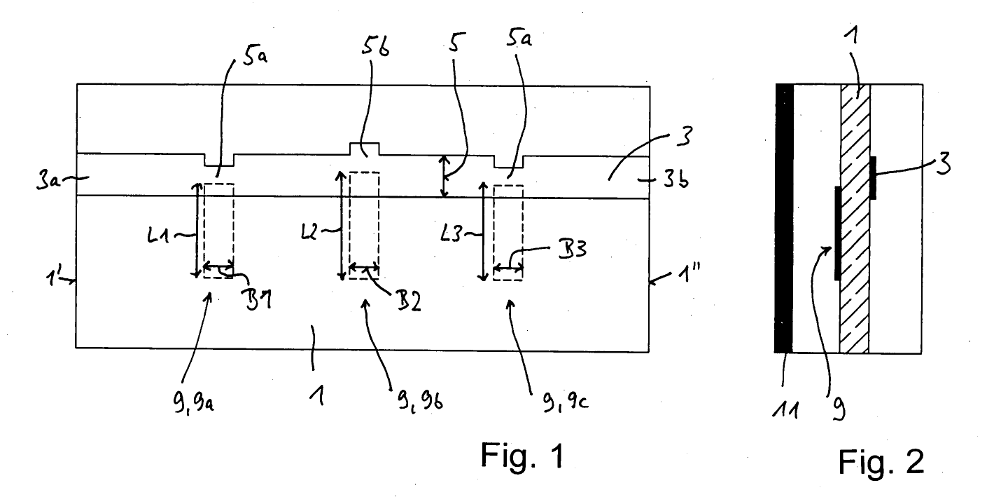

FIG. 1: shows a schematic illustration of a plan view of a first exemplary embodiment according to the invention of an RF resonator with capacitive coupling, and with a steeper flank on the upper band edge of the bandstop range;

FIG. 2: shows a cross section through the exemplary embodiment shown in FIG. 1, along the line II-II in FIG. 1;

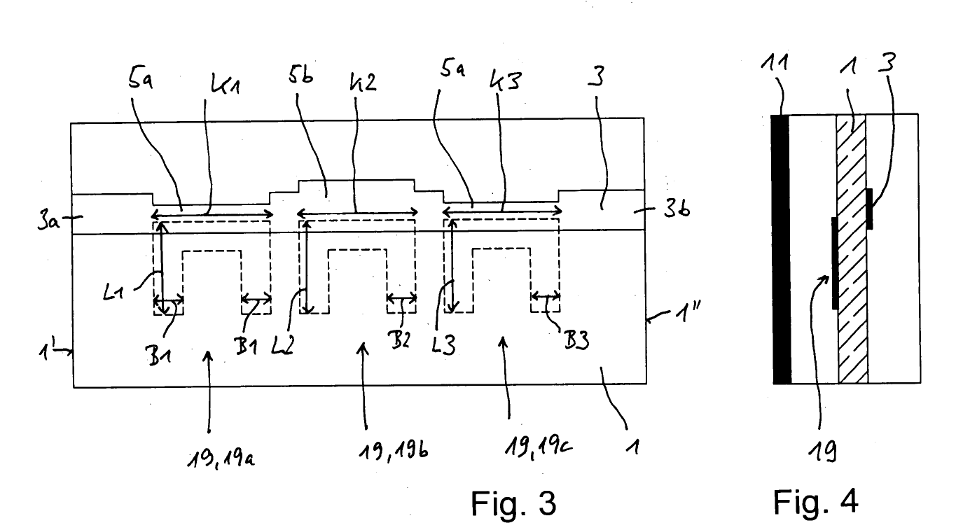

FIG. 3: shows an exemplary embodiment, modified from that shown in FIG. 1, of a schematic plan view of an RF resonator with inductive coupling and with a steeper flank on the lower bandwidth of the bandstop range;

FIG. 4: shows a cross-sectional illustration through FIG. 3, along the line IV-IV;

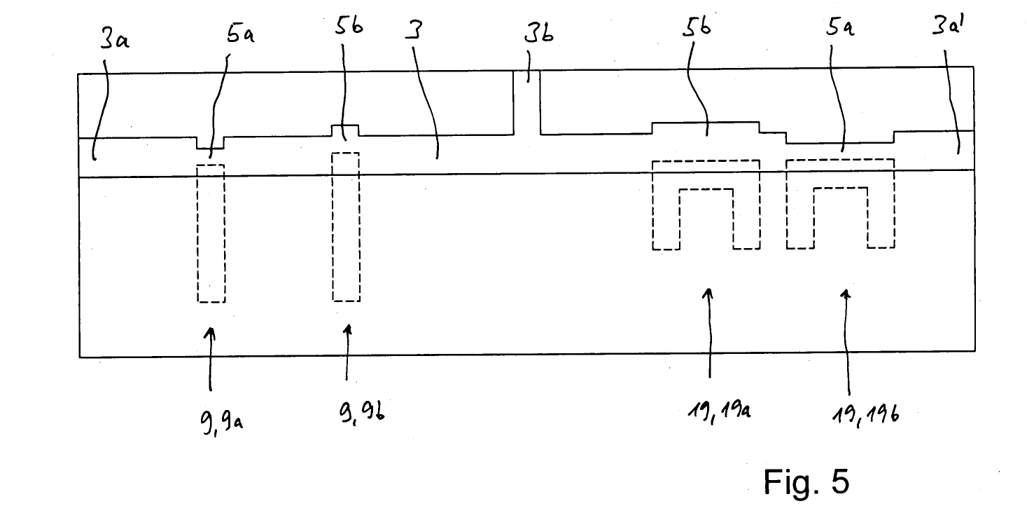

FIG. 5: shows an example of a duplex filter with inductive coupling in one branch of the duplex filter, and with capacitive coupling in the second branch of the duplex filter, in order to achieve a steeper flank towards the respective band that is to be blocked;

FIG. 6: shows an equivalent circuit of an RF filter with a resonator that is capacitively coupled to a continuous line;

FIG. 7: shows a diagram to illustrate the resonance response of a capacitively arranged resonator with a steeper flank/matching pole towards the higher frequency;

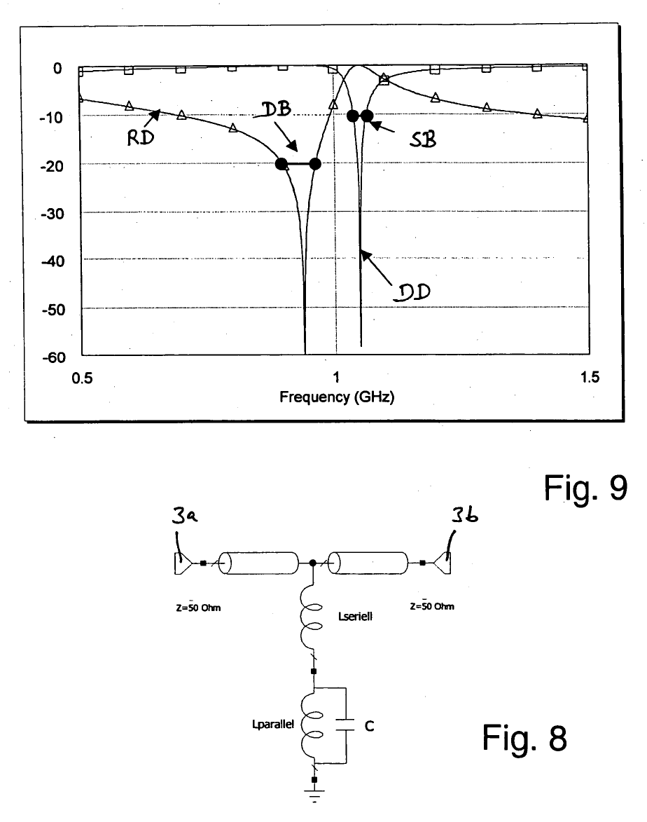

FIG. 8: shows an equivalent circuit of an RF filter with a resonator which is inductively coupled to a continuous line; and

FIG. 9: shows a diagram to illustrate the resonance response of an inductively arranged resonator with a steeper flank/matching pole towards the lower frequency;

FIG. 1 shows a first exemplary embodiment of an asymmetric bandstop filter with the resonators coupled capacitively. A continuous line 3 is for this purpose fitted to the upper face of a dielectric board 1, which is also referred to in the following text as a substrate 1. The line 3 has a length which corresponds to the length of the board 1, so that the line 3 is in this exemplary embodiment formed from the left-hand side 1′ of the board 1 to the right-hand side 1″ of the board 1, that is to say from the input 3a to the output 3b.

The line width 5 differs from its normal size in various sections. For example, the line width 5a is less than the normal size of the line width 5, and the line width 5b is larger than it.

Furthermore, three resonators 9, that is to say 9a, 9b and 9c, are provided on the dielectric board 1. The resonators 9a to 9c have the lengths L1, L2 and L3, respectively, and the associated respective widths B1, B2 and B3.

A ground surface 11, which in the illustrated exemplary embodiment corresponds to the size of the board 1, is provided underneath the substrate 1, and thus underneath the resonators 9 that are formed on the lower face of the substrate 1, and at a distance from them. Thus, in other words, the resonators 9 are formed on that face of the substrate 1 which faces the ground surface 11. A dielectric which, in the illustrated exemplary embodiment, is composed of air is located between the substrate 1 and the ground surface 11.

The resonators 9a to 9c which have been mentioned have an open circuit at their two free ends in the explained exemplary embodiment, that is to say their length preferably corresponds to half the wavelength of the first resonant frequency. With a resonator such as this having a length corresponding to the first resonant frequency, the electrical field is a maximum at both ends of the resonator while, in contrast, the magnetic field is a minimum at both ends.

In FIG. 1, the resonators that are provided on the lower face of the substrate are shown by dashed lines. FIG. 1 and the cross-sectional illustration in FIG. 2 show that one of the ends of each of the resonators 9a, 9b and 9c is in each case located on the opposite side of the substrate, in the immediate vicinity of the continuous line 3. This means that those ends of the resonators 9 which are close to the continuous line 3 overlap sections of the continuous line 3, or end at a short distance from it, when seen in a plan view at right angles to the board 1. The respective continuous line 3 is provided with the line constriction 5a or broadened line area 5b that has been mentioned precisely in that area in which those ends of the resonators 9 which are close to the line 3 end. The longitudinal size running in the longitudinal direction of the line 3 and in which the line constriction 5a and/or the broadened line area 5b are formed corresponds, in the illustrated exemplary embodiment, to the widths B1 to B3 of the resonators. Furthermore, this longitudinal size of the line constriction 5a and of the broadened line area 5b, and thus the width dimensions B1 to B3 of all three resonators are the same. These dimensions may, however, also be different, and may differ from one another, in individual cases.

The electrical field at the end of the resonator (in the area of the continuous line 3) provides the electrical/capacitive coupling for the respective resonator. The corresponding equivalent circuit for this is shown in FIG. 6.

The explained system with a capacitively coupled resonator comprises three reactances. In this system, a series resonance and a parallel resonance are stimulated at frequencies which can be selected.

$${f}_{parallel} = \frac{1}{2 π \sqrt{L {C}_{parallel}}}$$

$${f}_{series} = \frac{1}{2 π \sqrt{L {C}_{series}}}$$

Connecting Cₛₑᵣᵢₑₛ in series with the parallel-connected reactances L and Cₚₐᵣₐₗₗₑₗ as shown in FIGS. 1 and 2 to a continuous line 3 results in this line 3 being short-circuited for the series resonance, and being operated as a continuous line for parallel resonance. For series resonance, Cₛₑᵣᵢₑₛ and L govern the overall impedance of the circuit. This means that the impedance of the overall circuit is similar to that of a series resonant circuit, which means that the magnitude of the impedance of the circuit is low. For parallel resonance, Cₚₐᵣₐₗₗₑₗ and L govern the overall impedance of the circuit. This means that the impedance of the overall circuit is similar to that of a parallel resonant circuit, and that the magnitude of the impedance of the circuit is high. For the line, this corresponds to a blocking pole at series resonance, and a matching pole at parallel resonance.

In order to make it possible to set the stop frequency and the pass frequency as independently of one another as possible, three possible degrees of freedom must be taken into account, which can be adjusted in the sense of three variable parameters or three independent parameters.

In the case of capacitively coupled asymmetric bandstop filters, one variable degree of freedom relates to the length L1, L2 or L3 of the respective resonator. The second variable relates to the offset between the resonator and the continuous line (that is to say the offset in the transverse direction with respect to the longitudinal direction of the electrical line). The third variable is formed by the size of the line constriction 5a or broadened line area 5b. The required bandpass/bandstop response can be adjusted to the desired levels by suitable adjustment of these values. In this case, preferably:

fₛₑᵣᵢₑₛ<fₚₐᵣₐₗₗₑₗ

It is thus possible to modify a bandstop filter with capacitively coupled resonators such that the transitional region between the stop band and the pass band, which is located at higher frequencies, is reduced for a given number of resonators. Conversely, a predetermined requirement for the blocking effect can be satisfied with a very small number of resonators.

The following text refers to the exemplary embodiment illustrated in FIGS. 3 and 4, which show an asymmetric bandstop filter with inductive resonator coupling.

The same technical means are in this case provided with the same reference symbols.

In contrast to the exemplary embodiment shown in FIGS. 1 and 2, three resonators 19, that is to say resonators 19a, 19b, 19c, which are bent in a U-shape and are in the form of hairpins are formed on the dielectric board in the exemplary embodiment shown in FIGS. 3 and 4. The resonators have respective lengths of L1, L2 and L3. The width of the individual limbs of the U-shaped resonators is B1, B2 or B3, respectively. The overall width of the U-shaped resonators 19, that is to say their extent in each case from the outer edge of their limbs which run parallel to one another (and thus the length of the connecting section between the two parallel limbs) is equivalent to their coupling length K1, K2 or K3, respectively. In this case, as in the exemplary embodiment shown in FIGS. 1 and 2, the resonators 19 are likewise formed on the opposite side [lacuna] continuous line 3, and thus on the line face of the substrate 1 facing the ground surface 11. The resonators are once again likewise open circuit, that is to say their length preferably corresponds to half the wavelength of the first resonant frequency. With a resonator such as this, in which the length corresponds to half the wavelength at the resonant frequency, the electrical field is a maximum at both ends while, in contrast, the magnetic field is a minimum. The electrical field is in this case a minimum, and the magnetic field a maximum, in the center between the ends of the resonator.

In the exemplary embodiment shown in FIGS. 3 and 4, the central or connecting area 19′ of the resonators 19 which have been bent into a U-shape is also arranged such that this central area at least slightly overlaps the continuous line 3, when seen in a plan view of the substrate 1, or is located in its immediate vicinity. In the case of this explained exemplary embodiment, the continuous line 3 is likewise provided neither with a line constriction 5a nor with a broadened line area 5b in the area of the central section 19′ of the resonators 19, in which case the length in the longitudinal direction of the continuous line 3 of the line constriction 5a or of the broadened line area 5b may but need not correspond, for example, to the unobstructed internal distance between the parallel limbs 19b of the respective resonators 19.

The magnetic field in the center of the resonator in this case provides the electrical/inductive coupling for the respective resonator 19. The corresponding equivalent circuit is in this case shown in FIG. 8.

This explained system with an inductively coupled resonator also comprises three reactances. In this system, a series resonance and a parallel resonance are stimulated at frequencies which can selected.

$${f}_{parallel} = \frac{1}{2 π \sqrt{{L}_{parallel} C}}$$

$${f}_{series} = \frac{1}{2 π \sqrt{{L}_{series} C}}$$

The connection of Lₛₑᵣᵢₑₛ in parallel with the parallel-connected reactances Lₚₐᵣₐₗₗₑₗ and C as shown in FIGS. 3 and 4 to a continuous line 3 results in this line 3 being short-circuited for the series resonance, and being operated as a continuous line for parallel resonance. For parallel resonance, C and Lₚₐᵣₐₗₗₑₗ govern the overall impedance of the circuit. This means that the impedance of the overall circuit is similar to that of a parallel resonant circuit, that is to say the magnitude of the impedance of the circuit is high. For series resonance, C and Lₛₑᵣᵢₑₛ govern the overall impedance of the circuit. This means that the impedance of the overall circuit is similar to that of a series resonant circuit, that is to say the magnitude of the impedance of the circuit is low. For the line, this corresponds to a blocking pole for series resonance, and to a matching pole for parallel resonance.

In order to allow the stop frequency and the pass frequency to be adjusted as independently of one another as possible, three degrees of freedom or variables are also once again provided here, whose magnitudes can be adjusted independently of one another.

In the case of inductively coupled asymmetric bandstop filters, one variable is the length L1, L2 or L3 of a respective resonator 19. The second variable relates to the offset between the resonator and the continuous line. In this context, the expression offset should likewise again be regarded as a relative size, with which the U-shaped resonator is arranged offset relatively in the transverse direction with respect to the longitudinal direction of the continuous line 3. The central area 19′, which connects the two limbs of the respective resonator 19, is in this case arranged parallel to the continuous line 3, with the respective limbs 19′ of a respective resonator 19 being located transversely with respect to the longitudinal direction of the continuous line 3. The third variable relates to the size of the line constriction 5a or broadened line area 5b. In this exemplary embodiment as well, the required bandpass and bandstop response can be set by suitable adjustment of these three values. In this case, preferably:

fₚₐᵣₐₗₗₑₗ<fₛₑᵣᵢₑₛ

It is thus possible to modify a bandstop filter with inductively coupled resonators such that the transitional region between the stop band and the pass band, which is at lower frequencies, is reduced for a given number of resonators. Conversely, the corresponding circuit for a predetermined blocking effect can be achieved with a very small number of resonators.

FIG. 7 shows the resonance response of a capacitively coupled resonator corresponding to the equivalent circuit 6, showing the steeper flank towards higher frequencies (matching pole). In this case, the graph shows on the one hand the pass band attenuation DD, the stop band SB as well as the pass band DB and the return loss RD.

FIG. 9 shows the resonance response of an inductively coupled resonator, to be precise corresponding to the equivalent circuit shown in FIG. 8. In this case, the steeper flank towards the lower frequency (matching pole) can once again be seen. In this case as well, the graph shows the return loss RD, the pass band DB and, on the other hand, the stop band SB and the pass band attenuation DD.

FIG. 5 will now be used to explain how a duplex filter can also be constructed with the aid of the bandstop or RF filters.

In this case, FIG. 5 shows the possible interconnection of two bandstop filters. In this case, one bandstop filter as shown in FIGS. 1 and 2 is connected to a bandstop filter as shown in FIGS. 3 and 4 in order to form a duplex filter as shown in FIGS. 5 and 6, to be precise in such a way that the continuous lines at the first input 3a and from the opposite second input 3a′ are connected to form a common output line 3b, which is located in the center and continues transversely. In the exemplary embodiment illustrated in FIGS. 5 and 6, only two resonators are in each case provided in each branch of the relevant duplex filter, in contrast to the situation in the previous exemplary embodiments.

The interconnection shown in FIG. 5 (as illustrated) may be provided via transformation lines, but may also be provided via common resonators as well as via electrical or magnetic fields or other suitable types of interconnection.

If an asymmetric bandstop filter with inductive coupling is chosen for the filter element in the lower band (that is to say the passband for the lower frequency) and an asymmetric bandstop filter with capacitive coupling is chosen for the filter element in the upper band (that is to say the pass band is in this case that for the higher frequency), then the transitional region between the upper band and lower band is minimized for a given number of resonators. A corresponding circuit with a very much smaller number of resonators in comparison with bandpass filters can likewise be provided for a given selection requirement between the upper band and lower band.

1. Radio-frequency duplex filter, comprising:
a board or a substrate,
a continuous line disposed on the board or the substrates,
resonators are provided on the board or the substrate, on the opposite side to the continuous line,
the resonators being arranged offset with respect to one another in the longitudinal direction of the continuous line,
a ground surface offset parallel to the board or to the substrate, with a dielectric preferably being provided between the board or the substrate and the ground surface,
the resonators being coupled to the continuous line through a dielectric, preferably in the form of the board or of the substrate,
at least a portion of at least one resonator being arranged such that, when viewed at right angles to the board or to the substrate, at least a portion of one resonator
a) overlaps the continuous line, or
b) is at a very short distance from the continuous line, which is less than or equal to the width of the continuous line transversely with respect to its longitudinal direction, and
the continuous line having at least one line constriction or at least one broadened line area.

2. Radio-frequency filter according to claim 1, wherein at least a portion of at least one resonator is arranged such that, when viewed at right angles to the board or to the substrate, at least a portion of at least one resonator is at a maximum distance from the continuous line which is less than or equal to half the width of the continuous line.

3. Radio-frequency filter according to claim 1, wherein, when viewed at right angles to the board or to the substrate, at least a portion of all the resonators overlaps the continuous line, or its closest end or section is at a maximum distance from the continuous line which is equal to or less than half the width of the continuous line.

4. Radio-frequency filter according to claim 1, wherein the at least one line constriction and/or the at least one broadened line area is provided between two resonators.

5. Radio-frequency filter according to claim 1, wherein the continuous line has a line constriction or a broadened line area at least with respect to one resonator in the area in which the continuous line overlaps at least one section or one portion of the resonator or is at a minimum distance from the resonator there.

6. Radio-frequency filter according to claim 1, wherein the resonators are formed on that face of the board or of the substrate which faces the ground surface.

7. Radio-frequency filter according to claim 1, wherein the resonators are capacitively coupled to the continuous line.

8. Radio-frequency filter according to claim 7, wherein the capacitively coupled resonators have at least one stripline section which runs in a straight line and whose longitudinal direction is aligned such that it runs transversely, that is to say preferably at right angles, to the extent direction of the continuous line.

9. Radio-frequency filter according to claim 7, wherein the width of the capacitively coupled resonators corresponds in its longitudinal direction to the length of the line constriction or of the broadened line area of the line, or differs from it by no more than 50%, and preferably by less than 30%.

10. Radio-frequency filter according to claim 1, wherein the bandpass/bandstop response of the RF filter can be adjusted by means of the length of the respective resonator and/or by means of the extent of the line constriction or of the broadened line area and/or by the offset of the respective resonator from the continuous line, or by the extent of the overlap between the continuous line and the adjacent end of the respective resonator.

11. Radio-frequency filter according to claim 1, wherein the resonators are inductively coupled to the continuous line.

12. Radio-frequency filter according to claim 1, wherein the inductively coupled resonators are formed from stripline resonators with a U-shaped or approximately U-shaped plan view, which are arranged such that their respective central connecting section, by means of which the two limbs of the at least approximately U-shaped stripline resonators are connected to one another lies at least approximately parallel to the adjacent section of the continuous line.

13. Radio-frequency filter according to claim 1, wherein the width of the limbs of the stripline resonators is less than the longitudinal size of the line constriction or broadened line area.

14. Radio-frequency filter according to claim 1, wherein the overall width or coupling length of the resonators is greater than the longitudinal size of the line constriction or broadened line area.

15. Radio-frequency filter according to claim 1, wherein the bandpass/bandstop response of the RF filter can be adjusted by means of the length of the respective resonator and/or by the extent of the line constriction or of the broadened line area and/or by the offset between the respective resonator and the continuous line, or by the extent of overlap between the continuous line and the adjacent end of the respective resonator.

16. Radio-frequency filter according to claim 1, wherein a duplex filter is composed of two radio-frequency filter arrangements.

17. Radio-frequency filter according to claim 16, wherein one branch of the duplex filter comprises a bandstop filter with resonators coupled inductively, and the other branch comprises a bandstop filter with the resonators coupled capacitively.

18. Radio-frequency filter according to claim 16, wherein, in order to pass a lower band at a lower frequency, one branch of the duplex filter has an asymmetric bandstop filter with inductively coupled resonators, and, in order to pass a higher frequency in a higher band, the other branch has a bandstop filter with capacitively coupled resonators.

19. Radio-frequency filter according to claim 1, wherein the bandpass/bandstop response of the radio-frequency filter can be adjusted such that fₚₐᵣₐₗₗₑₗ<fₛₑᵣᵢₑₛ.

20. Radio-frequency filter according to claim 1, wherein the filter or the bandstop filter is asymmetric.
